(19) United States
(12) Patent Application Publication
(10) Pub. No.: US 2015/0175036 A1
(43) Pub. Date: Jun. 25, 2015

(54) CHILD CAR SEATS AND RELATED METHODS

(71) Applicant: Paul Gaudreau, JR., Indianapolis, IN (US)

(72) Inventor: Paul Gaudreau, JR., Indianapolis, IN (US)

(21) Appl. No.: 14/576,713

(22) Filed: Dec. 19, 2014

Related U.S. Application Data
(60) Provisional application No. 61/920,319, filed on Dec. 23, 2013.

(51) Int. Cl. B60N 2/28

(52) U.S. Cl. CPC B60N 2/2851; B60N 2/2869; B60N 2/2875; B60N 2/2821

(57) ABSTRACT

Child car seats and related methods are disclosed herein. An example child car seat comprises a shell having a head end and a foot end and a positioner disposed near the head end. The example positioner includes a recess to support a rear of a head of a child such that at least a portion of the rear of the head is not contacted by any portion of the car seat.

### RELATED APPLICATION

This patent claims the benefit of U.S. Provisional Patent Application Ser. No. 61/920,319, titled, “Child Car Seats and Related Methods” and filed on Dec. 23, 2013, which is hereby incorporated by reference in its entirety.

### FIELD OF THE DISCLOSURE

The present disclosure relates generally to child caretaking and, more particularly, to child car seats and related methods.

### BACKGROUND

Child car seats typically include a carrier shell and padding. The carrier shell provides structure defining a seat. The seat includes a head end, a foot end, and sidewalls. The padding is positioned within the seat to form a comfortable accommodation for a child.

### BRIEF DESCRIPTION OF THE DRAWINGS

FIG. 1 shows a perspective view of an example child car seat constructed in accordance with the teachings of this disclosure, shown supporting a child.

FIG. 2 is a perspective view of an example positioner, an example cushion, and an example carrier shell of the child car seat of FIG. 1.

FIG. 3A is an exploded, perspective view showing the example positioner of FIG. 2 detached from the example car seat to reveal an example fastener to secure the positioner to the seat.

FIG. 3B is a view similar to FIG. 3A but showing another example fastener.

FIG. 3C is a view similar to FIG. 3A but showing yet another example fastener.

FIG. 4A is a cross-sectional view of the example child car seat of FIG. 1 showing the child positioned in the seat and including a first type of positioner.

FIG. 4B is a view similar to FIG. 4A showing an alternative example positioner.

FIG. 4C is a view similar to FIG. 4A showing another example positioner.

FIG. 4D is a view similar to FIG. 4A showing yet another example positioner.

FIG. 5A is a profile view of the example car seat of FIG. 1 showing a first angle of recline.

FIG. 5B is a view similar to FIG. 5A, but showing the car seat at a second angle of recline.

FIG. 6 is a flowchart representative of a method for adjusting an example car seat and an example positioner in accordance with the teachings of this disclosure.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part (e.g., a layer, film, area, or plate) is in any way positioned on (e.g., located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Car seats are often employed to protect children (e.g. infants, toddlers, older children) from injury during transport in a motor vehicle. For safety of the child, many known car seats require the child to be positioned in an upright position. However, positioning a child in an upright position over an extended period of time may interfere with the child's breathing by reducing the child's airway through compression of the trachea. Such compression has a negative effect on the respiratory system of the child. In particular, seating a child in an upright position may lead to apnea, hypopnea, oxygen desaturation, or other conditions relating to reduced oxygen levels.

Some known car seats enable a child to be positioned in a non-upright position (e.g., 45° relative to ground). However, compression of the trachea may still occur in some such known car seats as a result of flexion of the child's neck. In such instances, the child's neck is rotated such that the angle between the child's head and chest is reduced. In some such known car seats, flexion of the child's neck results from a cushion of the car seat pushing the child's head forward relative to the child's chest. Furthermore, the cushion of some such known car seats has a smooth surface to receive the child's head. If a child lies in a reclined position (e.g., 45° relative to ground) against a smooth surface for an extended period of time, plagiocephaly, or flat head syndrome, may result. Plagiocephaly is a condition in which a side of a child's skull or the back of a child's head is flattened and/or compressed as a result of the child remaining in a supine position (i.e., lying down with the face up) for an excessively extended period of time.

Example child car seats disclosed herein substantially improve the posture of a child occupant of the seat to avoid the respiratory problems noted above and substantially reduce the risk of flat head syndrome. Example child car seats disclosed herein have a cushion coupled to a carrier shell. In some such examples, the carrier shell is coupled to a car seat base. In some examples, the cushion is reclined (e.g., 45° relative to ground) to enable a child to lie in a reclined position.

Some example child car seats disclosed herein include a shell and a pillow, insert or positioner. In some examples, the shell includes a head end and a foot end. In some examples, the shell is a car seat or carrier shell. In some examples, the positioner is disposed near the head end of the shell. Also, in some example child seats disclosed herein, the positioner engages and is positionable relative to a cushion coupled to the carrier shell. The example positioner is located to receive a head of a child occupant such that a portion of a rear of the head (e.g., the inion region of the head) is not contacted by any portion of the car seat.

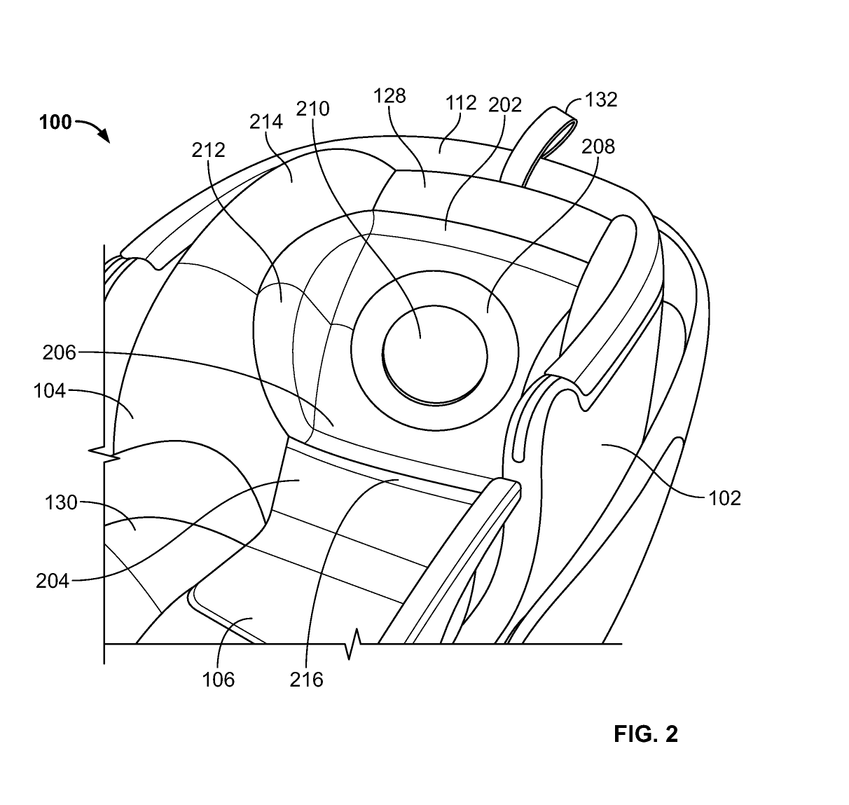

In some example child car seats, the positioner includes a ridge and an upper portion or section having a recessed surface that defines an opening (e.g., FIG. 2). In some such examples, the opening is configured to receive a rear portion of the head of the child. To reduce the risk of flat head syndrome, the recessed surface supports an outer portion of the back of the child's head and the opening enables a central portion of the back of the child's head to be free from, or to not engage, any surface of the example child car seat. The ridge projects outwards from the positioner adjacent the recess and supports a rear portion of a neck of the child to prevent flexion of the neck and, thus, improve the posture of the child and reduce negative effects on the respiratory system. In some examples, the position of the positioner relative to the cushion and/or the carrier shell may be adjusted to accommodate children of different ages and/or sizes.

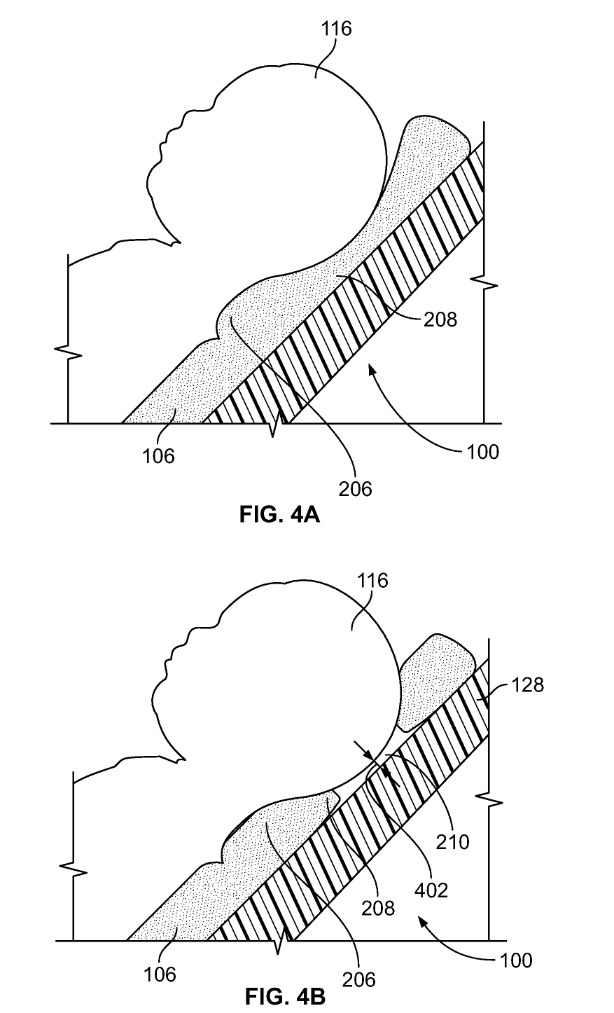

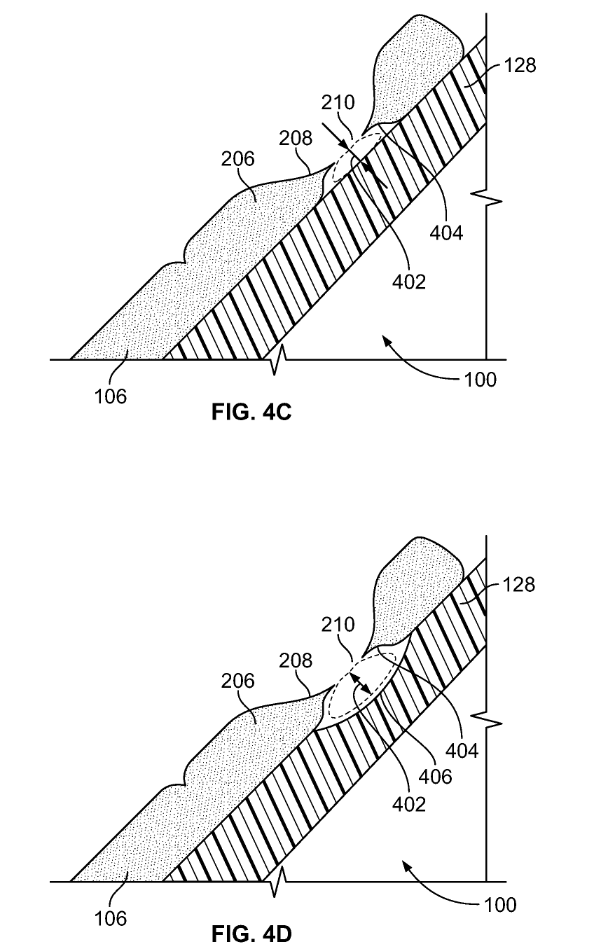

Some disclosed example child car seats have a positioner coupled to the carrier shell that includes a ridge to support a child's neck and a bowl (FIG. 4A) defined by a recessed surface to receive a back of the child's head. In some such examples, the position of the positioner may be adjusted relative to the carrier shell to accommodate children of different sizes and/or age. In some examples, the positioner is adjustable and may be positioned closer to a head end of the carrier shell to accommodate a relatively taller child, or alternatively, the positioner may be positioned further from the head of the shell to accommodate a relatively shorter child.

An example child caretaking device is disclosed herein that includes a shell having a head end and a foot end. In some examples, the shell is a car seat shell. In some examples, the car seat shell is a rear facing car seat. In some examples, the car seat shell is a forward facing car seat. The example child caretaking device also includes a positioner disposed near or coupled to the head end and a recess formed in the positioner to support a rear of a head of the child such that at least a portion of the rear of the head (e.g., the inion region of the head) is not contacted by any portion of the car seat.

In some examples, the positioner further comprises a ridge beneath a recess to support a neck of the child. The ridge projects from the top surface of the positioner away from the bottom (i.e., ground facing) surface. Additionally, in some examples, the position of the ridge is adjustable to align the ridge to the rear portion of the neck of the child to accommodate various sized children. Also, in some examples, the positioner further comprises an upper portion or first section, a lower portion or second section and a joint movably coupling the first section to the second section to enable the upper portion of the positioner to move relative to the lower portion of the positioner. In some examples, the lower portion extends towards the foot end of the shell and provides a surface to support the body of the child. In some examples, the recess is disposed in the first section. In some such examples, the recess comprises an aperture. The aperture of some such examples extends through the top surface of the positioner towards and through the bottom surface of the positioner. Also, in some examples, the recess comprises a rounded beveled surface such as, for example, a beveled surface surrounding the opening of the recess.

Some example devices include a cushion. In some such examples, the positioner is adjustable relative to the cushion and/or the shell between a first position and a second position. In the first position, the positioner is disposed at a first height relative to the head end. In the second position, the positioner is disposed at a second height relative to the head end. The second height is different from the first height. Also, in some examples, the positioner is slidable relative to the car seat shell or cushion.

In some examples, the positioner is directly or indirectly coupled to a cushion disposed in the car seat. In some examples disclosed herein, fasteners are provided for releasably and lockably coupling the positioner to the car seat shell and/or to a cushion disposed in the car seat. In some examples, the fasteners include a male connector and a mating female connector. The example device may include any number of male and/or female connectors to allow for securing the positioner relative to the car seat and/or cushion at multiple positions. In some examples, the positions are defined. In other examples, the positions are infinitely adjustable. In some examples the fastener to couple the positioner and car seat shell includes a track. Examples track enable the position to be adjusted by releasably sliding the positioner relative to the car seat shell. In some examples, the fastener includes loop and hook fasteners, such as Velcro®, to couple the positioner to the shell. Other suitable mechanical and/or chemical fastener(s) and/or combinations of fastener(s) may alternatively or additionally be used.

In some examples, the positioner further comprises side supports. The side supports may be attached to (e.g., fastened to) the positioner or integrally formed therewith. In some such examples, the recess is disposed centrally between the side supports. In some examples, the side supports are wing shaped and adjustable to provide additional support for a child occupant of the car seat. Some examples also include a flexible member frame to retain the positioner.

Also disclosed herein are examples systems to support a child in a vehicle. An example system includes a car seat base, a car seat coupled to the car seat base, and a positioner disposed in the car seat. The example positioner includes a top surface, a bottom surface, and a recess extending through the top surface toward the bottom surface such that a portion of a rear of a head (e.g., an inion region of a head) of the child is not contacted by any surface of the car seat.

In some example systems, the positioner further includes a neck support projecting from the top surface away from the bottom surface. In some example systems, the positioner is to releasably couple to the car seat. In some example systems, the positioner is to releasably couple to a cushion of the car seat. Also, in some example systems, the car seat is rotatably coupled to the car seat base, and in some examples, the car seat shell is reclinable.

Example methods disclosed herein include providing a car seat shell having a head end and a foot end, the head end disposed at a recline relative to the foot end. Some examples also provide a car seat base. In some examples, the car seat shell is coupled to and rotatable relative to the car seat base to adjust the angle of recline of the child. In some examples, the car seat shell rotates relative to the car seat base by a rotatable shuttle, platform, or central movable element. In some examples, a button is pressed to release the car seat shell from the car seat base. In some such examples, the car seat shell is positionable at multiple discrete positions on the car seat base, each position defining a different angle of recline. Such example methods also include providing a positioner to support a child such that a rear portion of the child's head is positioned closer to the surface of the shell than the neck and back of the child. In some examples, the positioner includes a recess to accept the rear portion of the head of the child occupying the car seat and a support ridge to support the neck of the child.

Some example methods include adjusting or repositioning the positioner relative to the shell. For example, the positioner may be slid between a first position and a second position. In other examples, the positioner is coupled to the car seat cushion via, for example, loop and hook fasteners. In some examples, to adjust the positioner from the first position to the second position, the positioner is decoupled from the cushion and subsequently reattached to the cushion. The first position of the positioner corresponds to a first height relative to the car seat shell. The second position of the positioner corresponds to a second height relative to the car seat shell.

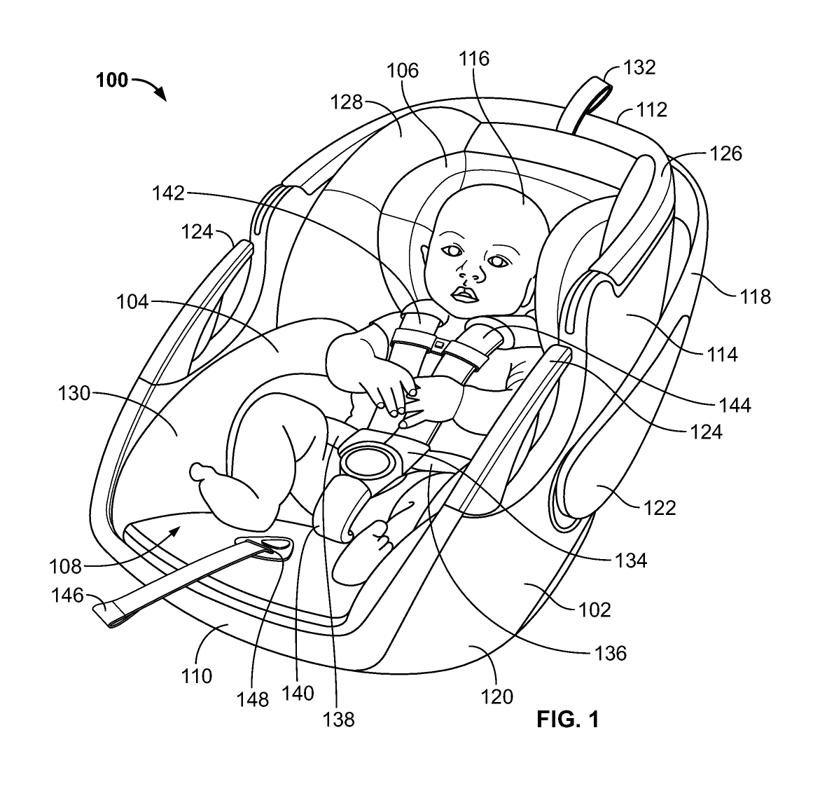

Turning to the figures, FIG. 1 is a perspective view of an example child car seat 100 disclosed herein. In the illustrated example, the child car seat 100 is a car seat that includes a carrier shell 102, a cushion 104, and a positioner 106. As illustrated in FIG. 1, a seat 108 is defined by a foot end 110, a head end 112, and sidewalls 114 of the carrier shell 102. When a child 116 is positioned in the seat 108, the child 116 rests in a reclined (e.g., 45° relative to ground), supine position between the sidewalls 114 such that feet of the child 116 rest adjacent the foot end 110 and a head of the child 116 rests adjacent the head end 112. The child 116 may be positioned at any suitable angle. In some examples, the angle at which the child 116 is reclined or positioned is adjustable. A range of suitable angles is dependent on the geometry of the child car seat and the size of the child. For example, for rear-facing child seats the angle of recline is in the range of about 30° to about 45°. Additionally, in some examples, the angle of recline is adjustable by rotating the carrier shell 102 relative to a car seat base. The carrier shell 102 may be composed of, for example, a plastic material such as a molded thermoplastic.

In the example illustrated in FIG. 1, a rotatable handle 118 is coupled to an exterior surface 120 of the carrier shell 102. In the example, the rotatable handle 118 defines ends 122 that are each rotatably coupled to a respective sidewall 114. The rotatable handle 118 of the illustrated example enables the example child car seat 100 of FIG. 1 to be conveniently carried to and/or from a motor vehicle, a stroller, a home or elsewhere. When the rotatable handle 118 is to be used to transport the child car seat 100, the rotatable handle 118 is rotated over the head end 112 of the carrier shell 102 to a position wherein the handle projects upwards above the approximate midsection of the child 116. When the example child car seat 100 is not being carried by a parent and/or other caretaker, and the parent or other caretaker wants access to the child car seat 100, (e.g., to remove a child from or place a child in the child car seat 100) the rotatable handle 118 is rotate to the position shown in FIG. 1. In some examples the rotatable handle 118 is to be positionable and lockable at several defined positions. Any suitable lock may be used to stop the rotatable handle 118 against rotation. For example, spring loaded lugs may be retractable and/or insertable into recesses of the shell 102.

The carrier shell 102 of the illustrated example includes side handles 124 protruding from the sidewalls 114. The side handles 124 of the illustrated example are fixed relative to the shell 102. The side handles 124 of this example are positioned near the middle of the shell 102 where the side handles 124 can be easily accessed and/or gripped to enable the child car seat 100 to be shifted, elevated and/or lowered (e.g., when being positioned in and/or being removed from the motor vehicle). In some examples where the carrier shell 102 is installed in a vehicle without a car seat base, the side handles 124 are open at one end to receive vehicle belts to secure the carrier shell to the seat. In the illustrated example, the side handles 124 are stationary and do not rotate or slide.

As illustrated in FIG. 1, a canopy 126 is coupled to the sidewalls 114 and/or the head end 112 of the carrier shell 102. In the illustrated example, the canopy 126 is rotatable relative to the head end 112 of the carrier shell 102 to cover and protect the child 116 (e.g., from unwanted sunlight or inclement weather). In some examples, the canopy 126 is able to be positioned between a fully open position, a collapsed position, and in a number of discretely defined positions between the fully opened and closed position. The canopy 126 of the illustrated example includes a plurality of canopy stays and a ratcheting mechanism cooperating with the stays to define the positions of the canopy.

The cushion 104 of the illustrated example includes an upper cushion 128 and a lower cushion 130. Both the upper and lower cushion 128, 130 are positioned within carrier shell 102 to define the seat 108. In the example illustrated in FIG. 1, the upper and lower cushions 128, 130 are permanently secured to the carrier shell 102. Alternatively, the upper and lower cushions 128, 130 may be detachably coupled to the carrier shell 102. To enable the child 116 to be comfortably positioned within the child car seat 100, the cushion 104 of the illustrated example is composed of, for example, a polyurethane and/or other foam and may be covered with a textile, a flexible plastic, and/or any other soft material. In the example illustrated in FIG. 1, where the upper and lower cushions 128, 130 are adjustably coupled to the carrier shell 102, a first strap 132 extends from the upper cushion 128 adjacent the head end 112 of the carrier shell 102. By pulling the first strap 132 in a direction away from the shell 102 (e.g., an upward direction away from the head of the child), the upper cushion 128 may be shifted and/or adjusted toward the head end 112 of the carrier shell 102 to enable a larger child to be properly positioned within the seat 108.

In the example illustrated in FIG. 1, safety straps 134 are coupled to and extend from and/or through the carrier shell 102, the upper cushion 128 and/or the lower cushion 130 of the child car seat 100. In the illustrated example, the safety straps 134 include two waist straps 136, 138 a crotch strap 140 and two shoulder straps 142, 144. In this example, the safety straps 134 are configured as a five point harness. In the example of FIG. 1, the positioner 106 defines openings that the harness straps are guided through. For example, when the child 116 is positioned in the example child car seat 100 of FIG. 1, the safety straps 134 interlock around the front of the child 116 to restrain movement of the child 116. The illustrated example car seat 100, also includes a second strap 146 that extends from a slot 148 defined by the lower cushion 130. In some such examples, the second strap 146 is attached to the crotch strap 138 and/or the shoulder straps 140 of the safety straps 134. The second strap 146 may be pulled in an outward direction (e.g., a direction away from the lower cushion 130) to tighten the safety straps 134 around the child 116 and, thus, further restrain movement of the child 116 within the child car seat 100.

The positioner 106 of the illustrated example is disposed over the cushion 104. As illustrated in FIG. 1, the positioner 106 receives at least the head of the child 116 when the child 116 is positioned in the child car seat 100. The position of the positioner 106 may be adjusted relative to the cushion 104 to accommodate children of different sizes and/or to accommodate the child 116 as the child 116 grows. For example, the positioner 106 may be shifted toward the head end 112 of the carrier shell 102 to receive a larger child and may be shifted toward the foot end 110 to receive a smaller child.

FIG. 2 illustrates the example positioner 106 of FIG. 1 in engagement with the cushion 104 of the example child car seat 100. The example positioner 106 of this example includes an upper portion 202, a lower portion 204, and a ridge 206 defined between the upper and lower portions 202 and 204. The upper portion 202 of the illustrated example includes a recessed surface 208 defining an opening 210 that extends therethrough. In some examples, the recessed surface 208 is a blind hole. In such examples, the recessed surface 208 may be a conical, beveled, or indented surface but lacks the opening 210. In some such examples, the recessed surface 208 forms a bowl (e.g., FIG. 4). In the illustrated example, the recessed surface 208, the ridge 206 and the opening 210 are centrally located between side supports 212 of the upper portion 202. The side supports 212 form wings to support and/or protect the sides of the child occupant's head. In some examples, the side supports 212 are adjustable and may be moved in toward the head of the child occupant or outward from the head. Further, in other examples the positioner 106 comprises a frame to hold the positioner in a desired configuration. For example, the frame may be implemented by a flexible wire.

In the example illustrated in FIG. 2, the upper portion 202 of the example positioner 106 is positioned adjacent the head end 112 of the carrier shell 102 and engages the upper cushion 128 of the child car seat 100. The lower portion 204 of the example positioner 106 of FIG. 2 is disposed on the lower cushion 130 and/or the upper cushion 128 of the car seat 100 based on the size of the child, for example. In examples of a relatively larger child positioned in the child car seat 100, the lower portion 204 of the positioner 106 may be at least partially disposed on the upper cushion 128. In examples of a relatively smaller child positioned in the child car seat 100, the lower portion 204 of the positioner 106 may be disposed at least partially on the lower cushion 130. The positioner 106 of the illustrated example is composed of flexible material to conform to the cushion 104 and provide a comfortable surface on which the child is to lie. For example, the positioner 106 may be composed of a polyurethane and/or other foam and covered with a textile, a flexible plastic, and/or any other suitable material.

When the child is positioned in the example child car seat 100, the recessed surface 208 of the upper portion 202 receives and supports an outer portion of the head of the child at the parietal and/or occipital areas of the head. For example, the inion, which is at the posteroinferior part of the skull, is supported in the recessed surface 208. As illustrated in FIG. 2, the side supports 212 of this example engage and are supported by side cushions 214 of the upper cushion 128. The side supports 212 of the illustrated example are positioned such that the child can freely rotate his or her head from side to side while providing additional cushioning should the child's head move far enough to the sides such as, for example, during abrupt movement of the vehicle.

As disclosed further herein, the opening 210 of the positioner 106 enables a curved portion of the head of the child to be free from and/or to not engage any surface of the child car seat 100 (e.g. FIG. 4B). Also, in some examples, a back surface of the positioner 106 may be concavely shaped or shaped in any other manner to create a gap 402 adjacent the opening 210 and between the back surface of the positioner 106 and the cushion 104 (e.g. FIG. 4C). In such examples, the gap prevents the head of the child from extending through the opening 210 of the positioner 106 and engaging the cushion 104.

Because the opening 210 of the example positioner 106 prevents a portion of the back of the head of the child from lying against any surface, the child car seat 100 substantially reduces the risk of plagiocephaly or flat head syndrome for the child. In particular, the opening 210 substantially reduces the risk of a rounded surface of the back of the head from flattening, which would otherwise result from the child lying in a reclined, supine position for an excessively extended period of time.

Additionally and/or alternatively, the upper cushion 128 of the child car seat 100 may define a cavity that aligns with the opening 210 of the example positioner 106 to further prevent the head of the child from engaging the upper cushion 128 (e.g. FIG. 4D). To ensure that the cavity and the opening 210 are aligned as the child car seat 100 is adjusted to accommodate the child as the child grows, the positioner 106 is attached to the upper cushion 128 and is repositionable relative the carrier shell 102 by pulling the first strap 132 attached to the upper cushion 128 in an outward direction.

In some examples, the upper cushion 128 receives the head of the child directly without use of the positioner 106. For example, the upper cushion 128 may incorporate the cavity of the positioner 106. In such examples, the cavity of the upper cushion 128 may resemble the recessed surface 208 of the positioner 106 of FIG. 2 to receive the head of the child and prevent a rounded portion of the back of the head from engaging any surface of the child car seat 100. In some such examples, the side cushions 214 of the upper cushion 128 enable the child to freely rotate his or her head while providing additional cushioning. In some such examples, the upper cushion 128 also defines a ridge 206 to support the neck of the child when the child is received by the cushion 104 of the child car seat 100. To accommodate the child as the child grows, the upper cushion 128 may be shifted relative to the carrier shell 102 by pulling the first strap 132 in a direction away from the foot end of the carrier shell 102.

The example positioner 106 illustrated in FIG. 2 includes a joint 216. The joint 216 of this example allows the upper portion 202 of the positioner 106 and the lower portion 204 of the positioner 106 to move relative to one another. For example, the upper portion 202 may pivot forward or toward the lower portion 204 if the child is to be positioned in a more upright position. Similarly, the upper portion 202 may pivot rearward or away from the lower portion 204 if the child is to be positioned in a more reclined position. Thus, in some examples, the joint 216 defines an axis of rotation to adjust the angle of recline of the upper portion 202 of the positioner 106 relative to the lower portion 204 of the positioner 106. Additionally, in some examples, the angle of recline of the child is further adjustable by rotating the carrier shell on the surface of a car seat base.

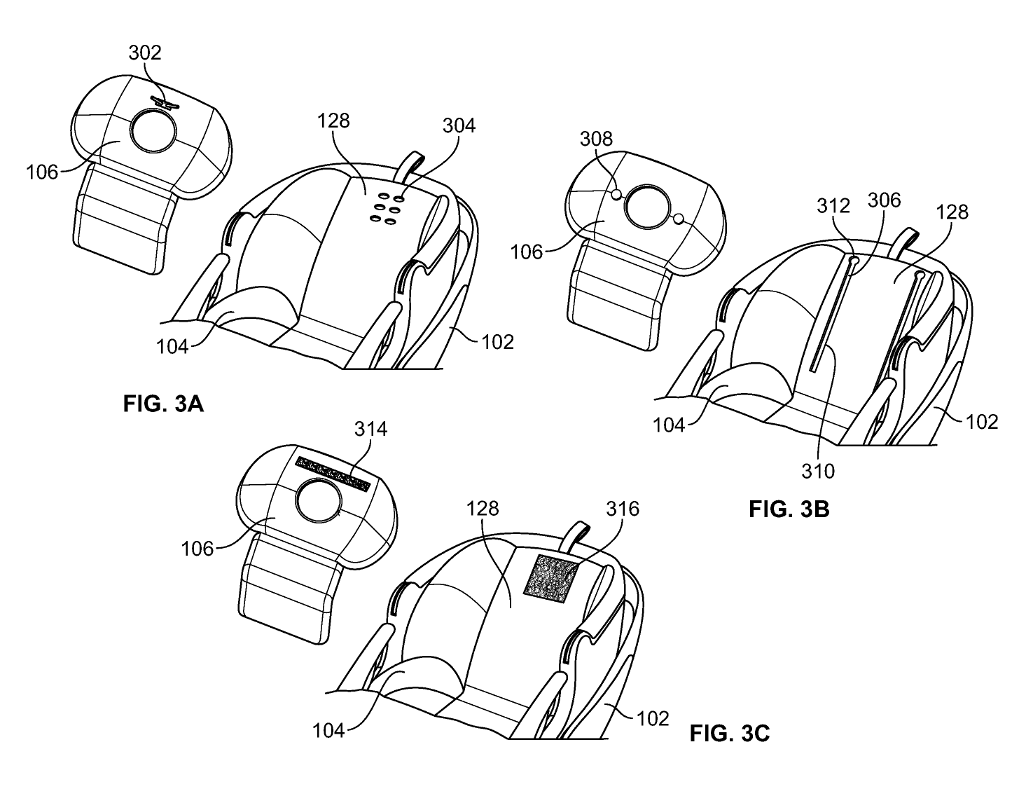

FIGS. 3A to 3C are perspective views of example implementations of portions of the child car seat with the example positioner 106 detached. The different example positioners 106 of FIGS. 3A-3B employ different example fasteners to couple the positioner 106 to the cushion 104 and/or carrier shell 102. In the illustrated example of FIG. 3A, one of the positioner 106 or the upper cushion 128 (or shell 102) includes one or more male connectors 302 and the other one of the positioner 106 or the upper cushion 128 (or shell 102) include one or more complementary female connectors 304 to mate with the one or more male connectors. In the illustrated example of FIG. 3A, the positioner 106 includes a series of male snaps 302 oriented, for example, in rows and the upper cushion 128 includes a series of female snaps 304 oriented, for example, in rows. The male snaps 302 of a first row may be coupled to respective ones of the female snaps 304 at a first row to arrange the positioner 106 at a first height. The male snaps 302 of the first row may be coupled to the female snaps 304 of a second row, different than the first row of female snaps, to arrange the positioner 106 at a second height, different than the first height. Similarly, the first row of male snaps 302 may be coupled to a third row of the female snaps 304 to lock the positioner 106 at a third height. For example, although only one row of male snaps 302 are shown in FIG. 3A, any number of rows of male snaps 302 may be present. Additionally or alternatively, there may be more or less than three rows of female snaps 304.

In the illustrated example of FIG. 3B, the example positioner 106 and the upper cushion 128 (or shell 102) are slidably coupled via a track 306 that may include one or more locking positions to arrange the positioner 106 at any of a continuous range of different heights. In this example, the positioner 106 includes one or more studs or rotatable wheels 308 that slidably engage one or more tracks 306. Also, in the illustrated example there are two tracks 306. In other examples there are one, three, or any other suitable number of tracks. The studs 308 or wheels 308 may have heads larger than the opening of channels 310 in the tracks 306. For example, the heads of the studs 308 or wheels 308 may be supported on shafts such that they are positioned a distance away from the positioner 106. The studs 308 or wheels 308 have a diameter larger than the opening of the channels 310. However, the diameter of the shafts supporting the studs 308 or wheels 308 are dimensioned to pass through the channel 310 (e.g. to be smaller than the width of the channel 310). The channels 310 of the example of FIG. 3B are in communication with recesses 312 dimensioned to receive respective ones of the studs 308 or wheels 308. Thus, the studs 308 or wheels 308 can be inserted into the channels 310 via the recesses 312 and thereafter slide up and down in the channel 310 behind the surface of the upper cushion 128. Because the diameter of the studs 308 or wheels 308 are larger than the width of the channels 310, the studs 308 or the wheels 308 can slide up and/or down within the channels 310 but cannot pass through the channels 310 except via the recesses 312. In some examples, the positioner 106 locks into place in the track 306. In other examples, there may be a release mechanisms (e.g., a button) to selectively retract the studs for movement of the positioner 106.

In the illustrated example of FIG. 3C, the example positioner 106 and upper cushion 128 (or shell 102) are releasably coupled through suitable loop and hook fasteners such as Velcro® fasteners. In the example of FIG. 3C, a strip of loops 314 is attached to the bottom surface of the positioner 106 and a patch of hooks 316 is attached to the top surface of the upper cushion 128 (or shell 102). The placement of the positioner 106 is adjusted by moving the loops 314 to engage different ones of the hooks 316. The position of the hooks and loops can be reversed such that the hooks are located on the positioner 106, and the loops are located on the cushion 128 or shell 102.

FIGS. 4A to 4D are cross-sectional views of example implementations of the positioner 106 of FIG. 1 with a child 116 positioned in the car seat 100. As illustrated in FIGS. 4A to 4D, the child 116 rests in a reclined (i.e., a non-upright), supine position. For example, while positioned in the child car seat, the child 116 may be positioned at a 30° angle, a 45° angle, a 60° angle, or any other non-perpendicular angle relative to ground.

In the illustrated example of FIG. 4A, the example positioner 106 include the recessed surface 208 as a bowl-like structure that lacks the opening 210. The recessed surface 208 of the example positioner 106 enables the head of the child 116 to protrude beyond the neck and back of the child 116 when the child 116 is positioned in the child car seat 100. In this position, the rear of the head including, for example, portions of the parietal and occipital bones sit further toward the shell of the car seat 100 than the neck and back. The ridge 206 of the illustrated example pushes or supports the neck of the child 116 forward relative to back of the child 116 to prevent the head from moving forward. When the child 116 is positioned in the child car seat 100, the recessed surface 208 and the ridge 206 of the example substantially improve the posture of the child 116 by ensuring that the head, neck, and back of the child 116 are properly aligned.

The recessed surface 208 and the ridge 206 of the example positioner 106 of the illustrated example also substantially reduce the risk of the child 116 developing respiratory problems related to reduced oxygen levels (e.g., apnea, hypopnea and/or oxygen desaturation) that are believed to develop when the air passageway of the child 116 is reduced. In particular, the recessed surface 208 and the ridge 206 of the example positioner 106 prevents compression of the trachea of the child 116, which would result in reduction of the air passageway, by preventing flexion of the neck of the child 116 (i.e., rotation of the head relative to the chest of the child 116). Because flexion of the neck occurs when the head is pushed forward causing the chin of the child 116 to move towards the neck of the child 116 the recessed surface 208 substantially reduces the risk of the child 116 developing such respiratory problems by enabling the back of the head to protrude beyond the back of the child 116. Also, because flexion of the neck occurs when the neck shifts back toward the back of the child 116, the ridge 206 substantially reduces the risk of the child 116 developing such respiratory problems by pushing or supporting the neck forward relative to the back of the child 116.

In the illustrated example of FIG. 4B, the example positioner 106 includes a recessed surface 208 surrounding the opening 210. The opening 210 enables the rear portion head of the child 116 to protrude beyond the neck and back of the child 116. The opening 210 creates a gap 402 between a rear region of the head of the child 116 and a surface of the upper cushion 128 of the child car seat 100 to enable a rear region of the head of the child 116 to not contact any surface of the upper cushion 128 of the child car seat 100.

In the illustrated example of FIG. 4C, the example positioner 106 includes two recessed surfaces 208, 404. The first recessed surface 208 is formed on a first or top side of the positioner 106 and makes contact with the head of the child 116. The second recessed surface 404 is formed on a second or back side of the example positioner 106. The second recessed surface 404 may be beveled, concavely shaped or have another suitable shape. In this example, the gap 402 is created adjacent the opening 210 and between the back surface of the example positioner 106 and the upper cushion 128. In such examples, the gap 402 prevents the head of the child 116 from engaging any surface of the upper cushion 128 of the child car seat 100. The second recessed surface 404 increases the size of the gap 402 as compared to the example of FIG. 4A, which further separates the head of the child 116 from the surfaces of the upper cushion 128 and/or carrier shell 102.

In the illustrated example of FIG. 4D, there is s third recessed surface 406. Specifically, as shown in FIG. 4D, the upper cushion 128 of the child car seat 100 includes the third recessed surface 406. The third recessed surface 406 aligns with the opening 210 of the example positioner 106. The gap 402 is defined by the second recessed surface 404 in the back of the positioner 106 and the third recessed surface 406 in the upper cushion 128. to further prevent the head of the child from engaging the upper cushion 128. The third recessed surface 404 further increases the size of the gap 402 as compared to the example of FIG. 4B, which further separates the head of the child 116 from the surfaces of the upper cushion 128 and/or carrier shell 102. In an alternative example, the third recessed surface 406 of FIG. 4D may be used with the example positioner of FIG. 4A and/or FIG. 4B.

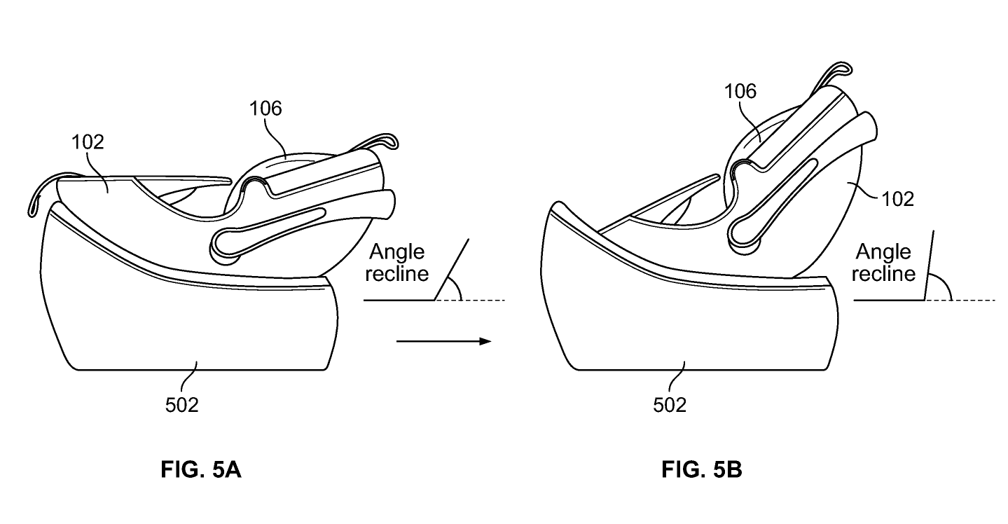

FIG. 5A is a profile view of the example positioner 106 of FIG. 1 coupled to the carrier shell 102 of FIG. 1. In the example of FIG. 5A, the carrier 102 is coupled to an example car seat base 502. The carrier shell 102 of this example is rotatable relative to the car seat base 502 to adjust the angle of recline of the child occupying the seat. This allows the child car seat 100 to accommodate children of different weight and sizes and/or to position a child in a desired position. In this example, the carrier shell 102 slides relative to the top surface of the car seat base 502 as shown in FIG. 5B. In some examples, the top surface of the car seat base 502 is curved to vary the orientation of the carrier shell 102 as the carrier shell 102 slides along the top surface of the car seat base 502. As the orientation of the carrier shell 102 changes, the angle of recline also changes as shown in FIG. 5B.

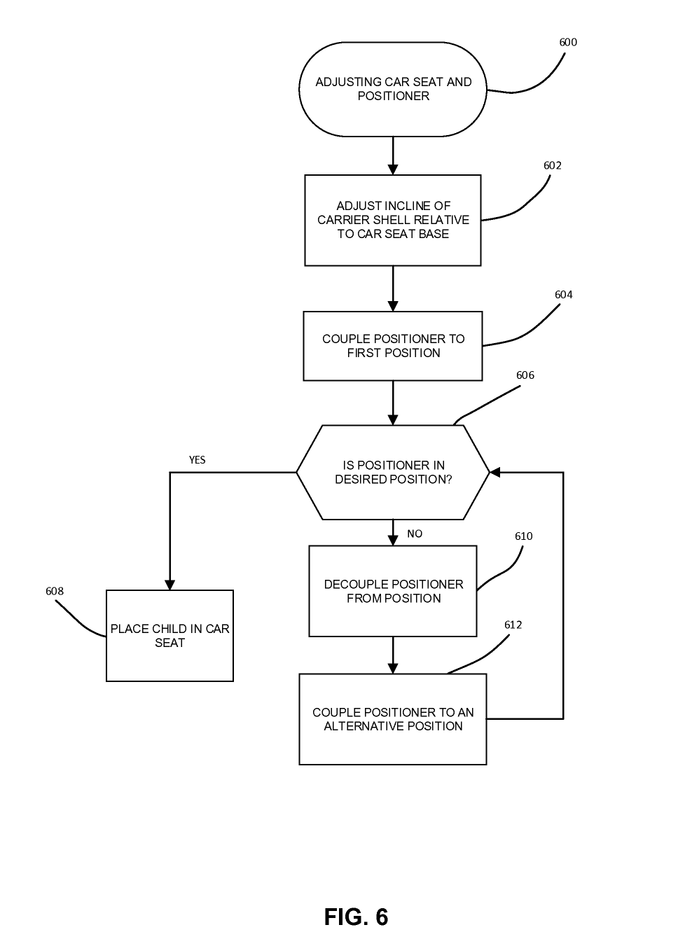

FIG. 6 is a flowchart illustrating an example process 600 for adjustment of an example car seat (e.g., the car seat 100) and an example positioner (e.g., the positioner 106) to accommodate differently sized children. Although the example process 600 is disclosed with reference to the flowchart illustrated in FIG. 6, many other methods of operating the example car seat 100 and the example positioner 106 may alternatively be used. For example, the order of execution of the blocks may be changed, and/or some of the blocks described may be changed, eliminated, or combined.

The example process 600 includes adjusting an angle of incline of a car seat or carrier shell relative to a car seat base (block 602). For example, the child caregiver can adjust the relative angle of include of the example carrier shell 102 relative to the example car seat base 502 described above.

The example process 600 also includes coupling a positioner to a first position (block 604). For example, the child caregiver can couple the example positioner 106 to the upper cushion 128 or the carrier shell 102 using the example fasteners disclosed above in FIGS. 3A-C including, for example, the example male snaps 302 and female snaps 304, the example studs or wheels 308 and tracks, or the example loop and hook fasteners 314, 316. The example process 600 also includes the child caregiver determining if the positioner is in the desired positioned (block 606).

If it is determined that the postioner is in the desired position (bock 606), the child caregiver can place the child into the car seat (block 608). For example, the child caregiver can place the child 116 into the example car seat 100 by placing the child 116 onto the example positioner 106 with the rear portion of the child's head aligned with one or more of the recessed surface 208, the opening 210, and/or the third recessed surface 406 and the neck of the child 116 supported by the example a ridge 206 as disclosed above.

If the child caregiver determines that the positioner is not in the desired position (block 606), the positioner is to be decoupled from the first position (block 610). For example, the child caregiver can determine the positioner is in a position meant for a larger or a smaller child. To decouple the positioner, the child caregiver can remove the example positioner 106 relative to the upper cushion 128 and/or carrier shell 102 by, for example, separating the example male and female connectors 302, 304 or the example loop and hook fasteners 314, 316 of FIGS. 3A and 3C, respectively. In other examples, there may be an adjustment without a full removal of the positioner 106 by, for example, adjusting or sliding the example studs or wheels 308 relative to the example tracks 306 of FIG. 3B.

The example process also includes coupling the positioner to an alternative position (block 612). For example, the child caregiver can move the example positioner 106 to an alternative position relative to the upper cushion 128 and/or carrier shell 102 using, for example, the example fasteners disclosed above in FIG. 3A, FIG. 3B, and/or FIG. 3C. After the positioner is coupled to the alternative position (block 612), the child caregiver determines if the positioner is in the desired position (block 606), and the example process 600 continues until the child caregiver determines that the positioner is in the desired position (block 606), and places the child in the car seat (block 608) as disclosed above.

Although the example positioner 106 is disclosed herein for use with a child car seat 100, the positioner 106 may be used with other types of child care devices including, for example, strollers, swings, bouncers, bassinets, sleeper inserts, carriers, playards, cribs and/or other devices.

Although certain example methods and apparatus have been disclosed herein, the scope of coverage of this patent is not limited thereto. On the contrary, this patent covers all methods, apparatus and articles of manufacture fairly falling within the scope of this disclosure.

What is claimed is:

1. A child car seat comprising:
a shell having a head end and a foot end; and
a positioner disposed near the head end, the positioner having a recess to support a rear of a head of a child such that at least a portion of the rear of the head of the child is not contacted by any portion of the car seat.

2. The child car seat of claim 1, wherein the shell comprises a car seat shell.

3. The child car seat of claim 1, wherein the positioner further comprises a ridge projecting outward adjacent the recess to support a neck of the child.

4. The child car seat of claim 1, wherein the positioner comprises a first section and a second section, the recess disposed in the first section, and the second section extending toward the foot end to support a body of the child.

5. The child car seat of claim 4, wherein the positioner comprises a joint movably coupling the first section to the second section.

6. The child car seat of claim 1, wherein the positioner comprises a beveled edge surrounding the recess.

7. The child car seat of claim 1, wherein the positioner further comprises side supports, the recess centrally disposed between the side supports.

8. The child car seat of claim 1, further comprising a fastener to releasably couple the positioner to the shell.

9. The child car seat of claim 1, wherein the positioner is adjustable relative to the shell between a first position and a second position.

10. The child car seat of claim 9, wherein, in the first position, the positioner is disposed at a first height relative to the head end and, in the second position, the positioner is disposed at a second height relative to the head end, the second height different than the first height.

11. The child car seat of claim 1, wherein the positioner is slidable relative to the shell.

12. A system to support a child in a vehicle comprising:
a car seat base;
a car seat coupled to the car seat base; and
a positioner disposed in the car seat, the positioner comprising:
a top surface;
a bottom surface; and
a recess extending through the top surface toward the bottom surface such that at least a portion of a rear of a head of the child is not contacted by any portion of the car seat.

13. The system of claim 12, wherein the positioner further comprises a neck support projecting from the top surface away from the bottom surface.

14. The system of claim 12, wherein the positioner is to releasably couple to the car seat.

15. The system of claim 12, wherein the positioner is to releasably couple to a cushion of the car seat.

16. The system of claim 12, wherein the car seat is rotatably coupled to the car seat base.

17. The system of claim 12, wherein the car seat shell is reclinable.
